(19) United States
(12) Patent Application Publication
(10) Pub. No.: US 2019/0160396 A1
(43) Pub. Date: May 30, 2019

(54) FOLDABLE AND REMOVABLE PARTITION ASSEMBLY FOR SEPTIC TANK

(71) Applicant: PRESBY PATENT TRUST, Whitefield, NH (US)

(72) Inventors: David William PRESBY, Sugar Hill, NH (US); Lee RASHKIN, Dalton, NH (US); John VLK, Wentworth, NH (US)

(73) Assignee: PRESBY PATENT TRUST, Whitefield, NH (US)

(21) Appl. No.: 15/998,910

(22) PCT Filed: Feb. 16, 2017
(86) PCT No.: PCT/US2017/018125

§ 371 Date: Aug. 16, 2018

Related U.S. Application Data
(60) Provisional application No. 62/295,835, filed on Feb. 16, 2016.

(51) Int. Cl. B01D 21/00; B01D 21/24; C02F 1/00; C02F 3/28; C02F 1/52; C02F 3/30; E03F 5/10

(52) U.S. Cl. CPC B01D 21/0042; B01D 21/2488; B01D 21/0003; C02F 1/006; C02F 3/2886; C02F 2203/006; C02F 3/30; E03F 5/105; E03F 5/101; C02F 2001/007; C02F 1/5236

(57) ABSTRACT

A foldable and removable partition assembly having both a collapsed configuration, which enables storage and transport of the foldable and removable partition assembly, and an expanded configuration which enables installation and use of the foldable and removable partition assembly within a septic tank. The foldable and removable partition assembly includes a framework that supports first and second partially overlapped baffles that form part of a sludge chamber of the septic tank.

### FIELD OF THE INVENTION

The present invention relates to a method and a device/apparatus for use in precipitating out suspended solids, particularly those found in septic tanks, and having the particular objectives, features and advantages of: 1) special formed longitudinal collection panels and support structure which will not restrict or inhibit the flow-through of liquid in a treatment or septic tank; 2) liquid flow directing devices which define a low resistance flow path and cause undulating and directed liquid flow; 3) compatibility with existing septic tanks; 4) collection panels with collection surfaces which are oriented to be parallel to low resistance flow path current and the counter current flow path of the liquid flow within the tank and permitting a higher resistance flow path which is a cross current flow-through of the panels; and 5) specially structured or adapted to be collapsible for easy transport and to create separate and distinct zones within a tank.

The present invention is directed to a septic tank system for causing the incoming liquid, or flowable composition which may have solid waste, and having the suspended materials suspended therein to flow along a generally undulating path along and thorough collection surfaces of longitudinal collection panels. The suspended solids collect, at least in part, simply due to contacting the mesh or screen supported by the longitudinal collection panel, it is believed, to turbulence created in the zone, chamber or region proximate to the collection panel surfaces. The mesh or screen of the longitudinal collection panels have perforation therethrough to allow for minimal perpendicular flow (higher resistance path) through of liquid and also to reduce the surface area of the collection surface resulting in the dislodging of the collected solids when the mass becomes substantially large. The globules—the locally accumulated collected solids—will either fall from the collection surface onto the bottom surface of the septic tank or float off and remain in the tank and not flow out into the leach system. More particularly, the longitudinal collection panels are preferably used in multiples within the septic tank and have flow directing openings located in a manner so as to cause the liquid flow to be undulating through the septic tank from the inflow to the outflow. There is also provided means for keeping the collection panels optimally located within the septic tank.

### BACKGROUND OF THE INVENTION

Suspended solids have plagued the septic system industry more in the last ten (10) or more years than in previous years. The increase in the problems is due in substantial part to the evolution and development of some of the modern day cleaners which now make cleaning easier in that they cause grease and oil to dissolve into the water. The major problem with a conventional septic tank is that the suspended solids, when passing through the tank, neither sufficiently cool nor make contact at a slow enough pace to separate from the water.

The control of lint and fuzz has also been an ongoing problem for septic tanks. These materials stay suspended in the septic tank liquid and normally passes through the septic tank, remaining suspended in the effluent, and subsequently cause problems in the leach field or system connected downstream of the septic tank.

Presently there is nothing available that provides for the removal, in a manner which does not affect the cost and the performance characteristics of the septic treatment system, of suspended solids that are typically found in liquid of a septic tank. It is important that the suspended solids do not exit from the septic tank so as to adversely affect the subsequent treatment of the wastewater/effluent. A leach field, for example, is adversely affected because the suspended solids will clog drain openings and also adversely affect the absorption characteristics of the leach bed.

Currently there are designs and equipment that attempt removal of the suspended solids from the liquid before the liquid exits from the septic tank. All of those known systems and apparatus fail to sufficiently address the problem in an efficient manner because all the efforts attempt to “filter” the liquid. It is to be appreciated that filtration creates an additional set of problems. In particular, filters can quickly become clogged or plugged thereby slowing down or completely blocking the flow of the liquid through the treatment or septic tank. Moreover, filters are expensive and are costly to maintain.

It is advantageous to have a treatment system which, without a large expense, prevents suspended solids from exiting the treatment or septic tank, does not require any additional maintenance, is incorporatable into a standard septic tank or other treatment tank configurations without changing the geometry and the structure of the treatment or septic tanks, is easily installed into existing and in-place treatment or septic tanks and has flexibility to incorporate a variety of component geometries, component materials and orientations to result in a custom system based upon special or specific needs within the treatment system.

As is known in the art, an Imhoff tank is a chamber suitable for reception and processing of sewage. An Imhoff tank may be used for the clarification of sewage by simple settling and sedimentation, along with anaerobic digestion of the extracted sludge. It generally consists of an upper chamber in which sedimentation takes place, from which collected solids slide down an inclined bottom slope into a lower chamber where the sludge is collected and eventually digested. The two chambers are otherwise unconnected, with sewage only flowing from the upper sedimentation chamber. The lower chamber typically requires separate biogas vents and pipes for the removal of digested sludge. The Imhoff tank is in effect a two-story septic tank and retains the septic tank's simplicity while eliminating many of its drawbacks, which largely result from the mixing of fresh sewage and septic sludge in the same chamber.

Biological nitrogen removal is a bacterially-mediated process. The goal of the denitrification process is to establish a fluctuating aerobic/anaerobic environment with carbon that bacteria can use to grow. The specific bacteria involved in converting Nitrogen in the nitrate (NO₃) form to diatomic nitrogen gas (N₂) are facultative aerobic bacteria who operate well under anoxic conditions. Anoxic conditions are comparable to dusk or dawn in terms of light levels experienced during a 24-hour period. During anoxic conditions, there is no appreciable “free” oxygen, but oxygen is present, bound into compounds such as carbon dioxide (CO₂) and nitrate (NO₃). Denitrifying bacteria are uniquely able to “breathe” the oxygen off the nitrate atom, releasing diatomic nitrogen gas (N₂) gas in the process, but must be fed carbon in order to survive. These denitrifying bacterial carry dual metabolic capabilities that allow them to thrive in both oxygen rich and oxygen deficient environments. Carrying both metabolic pathways exerts a high energetic cost to these bacteria. In exclusively anaerobic environments (like a standard septic tank) these denitrifying bacteria are outcompeted by more efficient obligate anaerobes. In exclusively oxygen rich environments (like mountain streams) they are outcompeted by more efficient obligate aerobes. A fluctuation between aerobic and anaerobic conditions (with a period of anoxic conditions between them) is a key requirement to encourage the presence and health of denitrifying bacteria and consequently a reduction of the nitrogen concentrations of discharges.

Currently, there is nothing currently available which satisfies all of the above noted needs and objectives.

None of the prior art known to the inventor hereof satisfies the need for removing solids which are suspended in the effluent liquid contained with a septic tank in an effective and high quality, simple and economically feasible way. It is to be appreciated that the precipitated solids form globules which then eventually either fall to the bottom of the treatment tank or float to the top surface. Most importantly, however, they stay in the tank for future removal by pumping. This prevents the suspended solids from flowing into the leach field or into a subsequent processing stage thereby keeping the leach system more effective for a longer period of time.

### SUMMARY OF THE INVENTION

Wherefore, it is an object of the present invention to overcome the above-mentioned shortcomings and drawbacks associated with the prior art. The present invention disclosed herein meets all of the above needs and objectives. The present invention, however, is not a filter system which has not been found to be effective and also has been found to be too difficult and costly to maintain.

Another object of the present invention is to as to provide a septic system which is effective in removing both nitrogen and phosphorus from sludge or waste material which accumulates in the effluent of the septic tank and is cost efficient.

A further object of the present invention is to provide a foldable and removable partition assembly which can be readily collapsed into a folded configuration or partially disconnected, in order to minimize transportation costs to a desired installation site and, thereafter, can be readily expanded/assembled into a use condition prior to installation.

An additional object of the present invention is to provide a foldable and removable partition assembly which is configured to create separate and distinct zones or regions within a septic tank so as to control a flow of effluent through the septic system and enhance the functionality of the treatment capabilities of a septic tank. The interior of the septic tank being partitioned by the removable assembly so as to form at least an inlet/treatment zone or region in which the sludge or waste material is retained and a clarified effluent zone or region in which clarified effluent collects before flowing out of the septic tank.

Yet another object of the present invention is to provide a septic system in which treated effluent, previously processed and clarified by the septic tank, can be recirculated or introduced back into the inlet/treatment zone or region in the septic tank in such a manner that the sludge or waste material is retained in the inlet/treatment zone or region. The treated effluent assists with stirring and mixing of the sludge or waste material that collects and accumulates in the inlet/treatment zone or region on the bottom surface of the septic tank and thereby facilitates temporary suspension of the carbon source, contained within the sludge or waste material in the effluent contained within the inlet/treatment zone or region of the septic tank and eventual collection of such carbon source on the mesh or screen of the foldable and removable partition assembly to assist with removal of nitrogen from the sludge or waste material.

A still further object of the present invention is to facilitate adding chemicals and other additives to the effluent, contained within the septic tank, in order to achieve a more complete breaking down and processing of the sludge or waste material which collects and accumulates with the septic tank.

Another object of the present invention is to accommodate a sufficient quantity of a metal material within the clarified effluent zone or region in order to assist with removal of phosphorus, from the effluent being processed with the septic tank, and thereby minimize the discharge of phosphorus into the leach field or ground.

Still another object of the present invention is to manufacture the foldable and removable partition assembly from a lightweight plastic material, such as PVC, so that the foldable and removable partition assembly does not disintegrate or decompose, within the septic tank, during use.

A still further object of the present invention is to provide a system which allows heavier materials to settle out and fall down to the bottom of the inlet/treatment zone or region in the septic tank while allowing the clearer effluent to flow toward the top surface of the septic tank and toward the clarified effluent zone or region of the septic tank.

Another object of the present invention is to facilitate the formation of iron phosphate, for example, which is heavier than water and typically settles along the bottom of the septic tank and thereby remove the phosphorus from the effluent.

Yet another object of this invention is to replicate an Imhoff process which allows increased retention of suspended solid particles within the effluent, for use as a carbon source during the denitrification process, as well as a mechanism for not disturbing the traditional processes of the septic tank.

The present invention also relates to a foldable and removable partition assembly having both a folded, collapsed configuration, which facilitates storage and transport of the foldable and removable partition assembly, and an expanded configuration which facilitates installation and use of the foldable and removable partition assembly within a septic tank. The foldable and removable partition assembly comprises a framework which supports at least an outlet plastic sheet for partitioning a clarified effluent zone or region of the septic tank from an inlet/treatment zone or region of the septic tank. The foldable and removable partition assembly may include at least one mesh or screen which can collect suspended particles in a treatment/sludge zone or region of the septic tank. A distribution tube returns treated effluent back to the septic tank for mixing up sludge or waste material contained on a bottom of the treatment/sludge zone or region the septic tank. The inlet/treatment zone or region can be subdivided by first and second baffles to form an inlet/scum zone or region above the baffles in which wastewater enters the septic tank and a treatment/sludge zone or region below the baffles of the septic tank and a supply of metal removes phosphorus from the sludge or waste material contained in the effluent of the septic tank.

The present invention is directed to a method and a device/apparatus/partition assembly for use in precipitating out—not filtering out—suspended solids, particularly those found in septic tanks. One or more collection panels are supported by a framework or structure. The framework or structure is preferably made of plastic tubing and is sized and configured to fit within a septic tank or other treatment tank. The collection panels are assembled onto the framework or structure at positions and in orientations which are predetermined to be most effective to precipitate out the types of suspended solids typically found in the incoming liquid to the treatment tank. The collection surface of the collection panels may all have the same texture and same sized apertures in the mesh or each of the panels may have different texture and mesh types or sizes. However, the optimum designed embodiment of the precipitation apparatus may be easily produced and installed.

An object of the invention is to provide a suspended solids precipitation device/apparatus/partition assembly which is effective in removes solids suspended in liquid flowing into a septic tank or treatment tank and causing the solid particles to remain in the tank for eventual removal by conventional pumping thereby making a conventional septic tank more efficient and more effective.

A further object of the invention is to provide a suspended solids precipitation device/apparatus/partition assembly which is easily and economically adaptable to meet specific design criteria which are based upon types and quantity of suspended solids found or expected in a treatment system and which when in use, will increase the life expectancy of a leaching system or field and reduce the normal size or area of a leach system.

A still further object of the invention is to provide a suspended solids precipitation device/apparatus/partition assembly which is designed to reduce ground water contamination.

A further object of the invention is to adaptively locate the suspended solids precipitation device/apparatus/partition assembly within a sewage and wastewater treatment tank. The suspended solids precipitation device/apparatus/partition assembly, when placed within the treatment or septic tank, causes substantial amounts of suspended solids within the liquid flowing into the treatment or septic tank to remain within the treatment or septic tank thereby substantially reducing an amount of suspended solids flowing out of the treatment or septic tank. The suspended solids precipitation device/apparatus/partition assembly comprises at least one collection panel, but preferably a plurality of collection panels each having two back-to-back collection surfaces, each of the collection surfaces has a surface texture which promotes the precipitation thereon of the suspended solids.

A further object of the invention is to provide the texture of the collection surfaces with a mesh having a plurality of apertures therethrough, and the apertures each having a selected area measure. The area measure selected is a function of material characteristics of the suspended solids. The mesh may be selected from at least one of the materials selected from the group consisting of nylon mesh, metallic mesh, plastic mesh, fiberglass mesh, fabric mesh, woven wood and plastic or any other suitable material.

A still further object of the invention is to manufacture the suspended solids precipitation device/apparatus/partition assembly from a plastic tube framework or structure with a plurality of collection panel assembled thereon. Spacer members and a plurality of legs are also included. The legs and spacer members are adapted to locate and maintain the location of the collection panel or the number of collection panels relative to each other and positioned and oriented within the treatment tank spaced from the side walls.

A yet still further object of the invention is to support the collection panels (where more than one is used) in a manner such that the collection surfaces are substantially vertical to a bottom surface of the treatment or septic tank and each adjacent collection panel has a flow directing aperture therethrough.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. The invention will now be described, by way of example, with reference to the accompanying drawings in which:

FIG. 1 is a diagrammatic view showing a first embodiment of the septic system according to the present invention;

FIG. 1A is a diagrammatic view showing the various separate zones or layers of material accommodated within the septic tank according to FIG. 1;

FIG. 1B is a diagrammatic view showing the various separate zones or layers of material accommodated within a convention prior art septic tank;

FIG. 2 is a diagrammatic view showing a second embodiment of the septic system according to the present invention;

FIG. 3 is a sectional view showing a lower portion of the expanded foldable and removable partition assembly with the mesh or screen of the interior longitudinal panels according to the present invention;

FIG. 3A is a diagrammatic section view of a distribution tube of the expanded foldable and removable partition assembly shown along a bottom of the septic tank

FIGS. 4 and 4A are pictorial front elevational views of the leading end of the expanded foldable and removable partition assembly in a transportation position with the distribution tube detachable conduit section;

FIG. 4B is a diagrammatic top view of the framework of the expanded foldable and removable partition assembly in a partially folded transportation position;

FIG. 5 is a pictorial front elevation view of the leading end of the expanded foldable and removable partition assembly in a partially assembled position with the distribution tube detachable conduit section detached from a remainder of the foldable and removable partition assembly;

FIG. 5A is a diagrammatic side elevation view illustrating couplings of the framework of an outer longitudinal panel of the foldable and removable partition assembly

FIG. 6 is a diagrammatic front elevational view of the expanded foldable and removable partition assembly;

FIG. 6A is a diagrammatic front elevational view illustrating couplings of the expanded foldable and removable partition assembly;

FIG. 7 is a diagrammatic perspective view of the expanded foldable and removable partition assembly arranged in an unenclosed septic tank;

FIG. 8 is a diagrammatic elevational view of the expanded foldable and removable partition assembly arranged in an unenclosed septic tank;

FIG. 9 is a diagrammatic perspective view of the expanded foldable and removable partition assembly with a rear partition sheet fixed to the trailing end of the expanded foldable and removable partition assembly;

FIG. 9A is a diagrammatic view of the expanded foldable and removable partition assembly within a septic tank illustrating a flow path of effluent therein;

FIG. 10 is a diagrammatic elevational view of the trailing end of the expanded foldable and removable partition assembly with the outlet plastic sheet attached thereto forming a seal with sidewalls of the septic tank to divide septic tank into distinct zones or regions;

FIG. 11 is a diagrammatic elevational view of the trailing end of the expanded foldable and removable partition assembly without the outlet plastic sheet attached thereto;

FIG. 12 is a diagrammatic sectional view along section line 12-12 of FIG. 11, showing the mesh or screen of one interior longitudinal panel according to the present invention;

FIG. 13 is a diagrammatic sectional view along section line 13-13 of FIG. 11, showing the mesh or screen of the other interior longitudinal panel according to the present invention;

FIG. 14 is a diagrammatic side elevation view along section line 14-14 of FIG. 11, showing the mesh or screen of an outer longitudinal panel showing more clearly the waste removal conduit according to the present invention according to the present invention;

FIG. 15 is a diagrammatic side elevational view of the expanded foldable and removable partition assembly with the outlet plastic sheet attached thereto and showing more clearly the waste removal conduit according to the present invention according to the present invention, and

FIG. 16 is a diagrammatic perspective view showing the trailing end of the expanded foldable and removable partition assembly with the outlet plastic sheet attached thereto.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION OF THE PREFERRED EMBODIMENTS

The present invention will be understood by reference to the following detailed description, which should be read in conjunction with the appended drawings. It is to be appreciated that the following detailed description of various embodiments is by way of example only and is not meant to limit, in any way, the scope of the present invention.

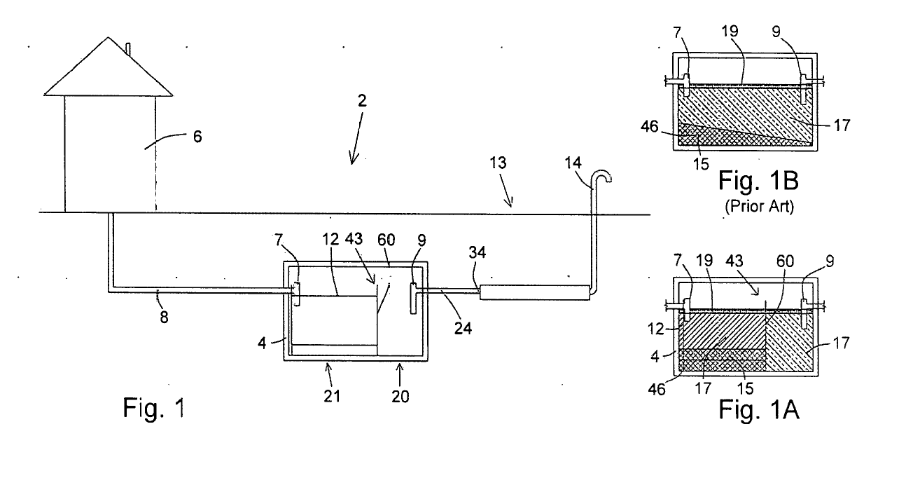

Turning now to FIG. 1, a brief description concerning the various components of the present invention will now be briefly discussed. As can be seen in this Figure, the septic system 2 includes a septic tank 4 which is buried underground in a conventional manner. It is to be appreciated that the overall size and shape of the septic tank 4 can vary, depending upon the particular application, whether it be treating wastewater flow from a single household, a community or one or more commercial properties, for example. As generally shown in FIG. 1, the septic tank 4 is coupled or connected, via a waste supply conduit 8, downstream of a house, a building or some other structure 6 for supplying waste from the house, the building or the other structure 6 to the septic tank 4 for processing. It is possible, but not required, that the house, the building or the other structure 6, may be equipped with a conventional roof vent which facilitates venting of the septic tank 4 so that gases (such as nitrogen) and other fumes, which are generated during operation of the septic tank 4, can be exhausted and vented.

The wastewater from the house, the building or the other structure 6 flows along the waste supply conduit 8, in a conventional manner, and enters into the septic tank 4 via an inlet T-shaped connector 7. The inlet T-shaped connector is arranged to discharge and direct the supplied wastewater toward a bottom surface of the septic tank 4. According to the prior art as show in FIG. 1B, a conventional septic tank generally comprises a single treatment region which extends from the inlet T-shaped connector 7 to the outlet T-shaped connector 9 of the septic tank. That single treatment region (see FIG. 1B) comprises a lower sludge layer 15, a floating scum layer 19 and an intermediate clarified layer 17. The conventional septic tank provides a substantially anaerobic bacterial environment which decomposes or mineralizes the wastewater discharged into the septic tank and generally reduces the volume of the solids. The liquid effluent of the wastewater, located between the lower sludge zone 15 and floating scum zone 19, becomes relatively clear and forms the intermediate clarified zone 17. The effluent drains through an outlet T-pipe connection 9 that forms the septic tank outlet, and flows downstream where further processing/settlement of the effluent can occur before being discharged into the environment.

According to the present invention, a foldable and removable partition assembly 12 is installed within the septic tank 4, between the inlet and the outlet T-pipe connections 7, 9. A trailing end 43 of the foldable and removable partition assembly 12 supports a barrier or a partition, e.g., an outlet membrane or sheet 60, discussed below in further detail, which is located between the inlet and the outlet T-pipe connections 7, 9. As generally shown in FIG. 1A, this partition or barrier divides the septic tank 4 into an inlet/treatment zone or region 21 and a clarified effluent zone or region 20. The inlet/treatment zone or region 21 directly communicates with the inlet T-pipe connection 7 and generally comprises, similar to the prior art, a lower sludge layer 15, a floating scum layer 19 and a partially clarified layer 17. The clarified effluent zone or region 20, which is located downstream of the trailing end of the foldable and removable partition assembly 12, only comprises a floating scum layer 19 and a lower clarified layer 17. The treated effluent is at least substantially removed from the clarified layer 17 of the clarified effluent zone or region 20, just below the floating scum zone 19 without any, or only an insignificant amount of sludge contained within the clarified effluent zone or region 20.

The outlet T-shaped connector 9 of the septic tank 4 is connected, via an effluent exhaust conduit 24, to an inlet end of the leach field conduit 34 which, in turn, distributes the treated effluent, in a conventional manner, throughout the leach field 13 where the treated effluent is permitted to slowly and gradually permeate and leach into the ground over the course of time.

Since the leach field 13 does not form any part of the inventive aspect of the present invention, a further detailed description concerning the same is not provided. It is to be appreciated that, depending upon how clean the effluent is and the local, region, state and/or federal requirements for the discharge of treated effluent, the treated effluent may possibly be discharged directly into the ground or directly into a stream or other waterway, etc., rather than being transported to a leach field 13.

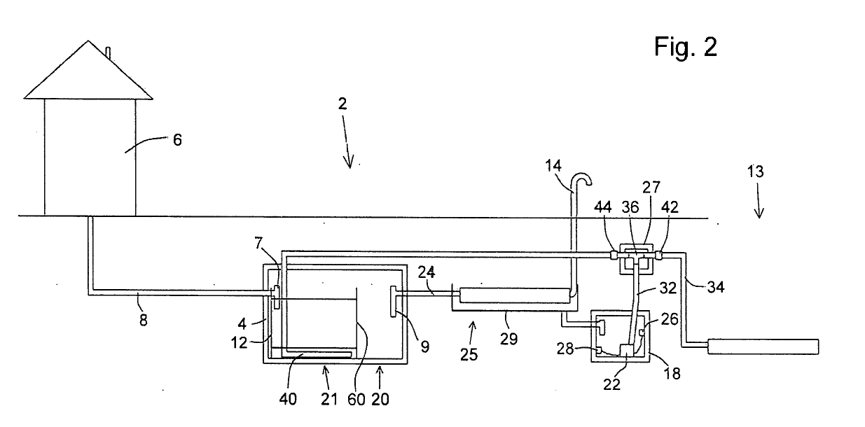

Turning now to FIG. 2, a second embodiment of the present invention will now be described. As this embodiment is very similar to the first embodiment, only the differences between this second embodiment and the first embodiment will be discussed in detail while identical elements will be given identical reference numerals.

The basic differences between the second embodiment and the first embodiment is inclusion of an aerobic system 25 downstream of the septic tank 4, and a recirculating tank 18, downstream of the aerobic system 25, which pumps the treated effluent from the recirculating tank 18, a flow divider 27, either back to the septic tank 4 or to the leach field and into the ground 13, through spray irrigation or through discharge into a stream or other waterway, etc., depending upon how clean the treated effluent is and the local, region, state and/or federal requirements for the discharge of treated effluent.

According to the first embodiment, all the treated effluent from the septic tank 4 is permitted to flow either directly to the leach field 13 for leaching into the ground, in a conventional manner, or into the ground, into a stream or other waterway, etc., depending upon how clean the treated effluent is and what the local, region, state and/or federal requirements are for the discharge of treated effluent. According to the embodiment of FIG. 2, the outlet T-shaped connector 9 of the septic tank 4 is connected, via an effluent exhaust conduit 24 to the aerobic system 25 which receives the treated effluent from the septic tank 4. The aerobic system 25 generally comprises a permeable membrane which surrounds the treated effluent which flows into the aerobic system 25. As a result, any small particles still remaining in the treated effluent located within the aerobic system 25 is permitted nitrify. The treated effluent is permitted to gradually permeate through the permeable membrane and collect in a collection liner located below the aerobic system 25. The treated effluent, which collects within the collection liner 29, is then channeled and directed into a recirculating tank 18. The overall size and shape of the collection liner 29 and the aerobic system 25 can vary, depending upon the particular application.

A recirculating tank pump 22 is accommodated within lower portion/bottom surface of the recirculating tank 18 and utilized for periodically pumping and at least partially emptying the treated effluent which eventually accumulates and collects in the recirculating tank 18. If desired, the recirculating tank 18 can be connected to an air inlet tube (not shown) for supplying air into the treated effluent which is pumped by the recirculating tank 18. It is to be appreciated that the overall size and shape of the recirculating tank 18 can vary, depending upon the particular application.

If desired, the recirculating tank pump 22 may possibly be equipped with a high level liquid sensor 26 and a low level liquid sensor 28 which facilitate automatic operation of the recirculating tank pump 22. That is, when the treated effluent level within the recirculating tank 18 is sufficiently high so that the high level liquid sensor 26 is activate or “tripped”, the high level liquid sensor 26 sends a signal to the recirculating tank pump 22 to commence pumping of treated effluent from the recirculating tank 18 until the low level liquid sensor 28 indicates that the treated effluent remaining within the recirculating tank 18 is at or below the position of the low level liquid sensor 28. Once this occurs, the low-level sensor 28 activates or “trips” and sends a signal to the recirculating tank pump 22 which shuts off the recirculating tank pump 22 and thereby discontinues further pumping of treated effluent from the recirculating tank 18. Alternatively, the recirculating tank pump 22 may be operated on demand or may be automatically operated periodically, e.g., every few hours or so, to partially empty the recirculating tank 18.

When the recirculating tank pump 22 is activated, the recirculating tank pump 22 pumps the effluent from the recirculating tank 18 via a recirculating tank discharge conduit 32. A “T” or a “Y” connector 36, for example, may be provided along the recirculating tank discharge conduit 32 from the holding tank 18, such as at the flow divider 27 for dividing or separating the pumped treated effluent into first and second supply sources. The first supply source of treated effluent is typically fed along a section of the holding tank discharge conduit 32 to the inlet end of the leach field conduit 34 where the processed fluid is typically distributed and permitted to slowly and gradually permeate and leach into the ground over the course of time or, depending upon how clean the treated effluent is and the local, region, state and/or federal requirements for the discharge of treated effluent, this treated effluent may possibly be sprayed or discharged into the ground, discharged into a stream or other waterway, etc. The second supply source, on the other hand, may be fed via a septic tank return conduit 38 directly to a distribution tube 40 which is located within the lower portion 12 within the septic tank 4.

As shown in FIG. 2, the aerobic system 25 may be equipped with the air inlet pipe 14 which facilitates supplying air into the aerobic system 25 to facilitate proper operation thereof. If the treated effluent is pumped to the leach field conduit 34, the leach field conduit 34, in turn, distributes the treated effluent, in a conventional manner, throughout the leach field 13 where the treated effluent is permitted to slowly and gradually permeate and leach into the ground over the course of time. Since the leach field 13 does not form any part of the inventive aspect of the present invention, a further detailed description concerning the same is not provided.

The holding tank discharge conduit 32 is typically equipped, downstream of the “T” or the “Y” connector 36, with a first regulatable switch, valve, flow regulator, etc., 42 while the septic tank return conduit 38 is typically equipped, downstream of the “T” or the “Y” connector, with a second regulatable switch, valve, flow regulator, etc., 44. Although the first and second regulatable switches, valves, flow regulators, etc., 42, 44 are illustrated as being located downstream from the flow divider 27 it is to be appreciated that the first and second regulatable switches, valves, flow regulators, etc., 42, 44 can alternatively be arranged within the flow divider 27. The first and second regulatable switches, valves, flow regulators, etc., 42, 44 permit the system 2 to easily adjust the amount of treated effluent that is pumped to either the septic tank 4 or the leach field 13, etc. It is to be appreciated that the first and second regulatable switches, valves, flow regulators, etc., 42, 44 may be controlled or adjusted by hand or may be coupled to a control system and controlled automatically. Typically, between little to all of the treated effluent, pumped from the holding tank 18, is supplied directly to the leach field 13 or other treated water discharge while between little to all of the treated effluent is returned back to the septic tank 4 to assist with stirring and mixing up of the sludge or waste material 46 which accumulates on the bottom of septic tank 4.

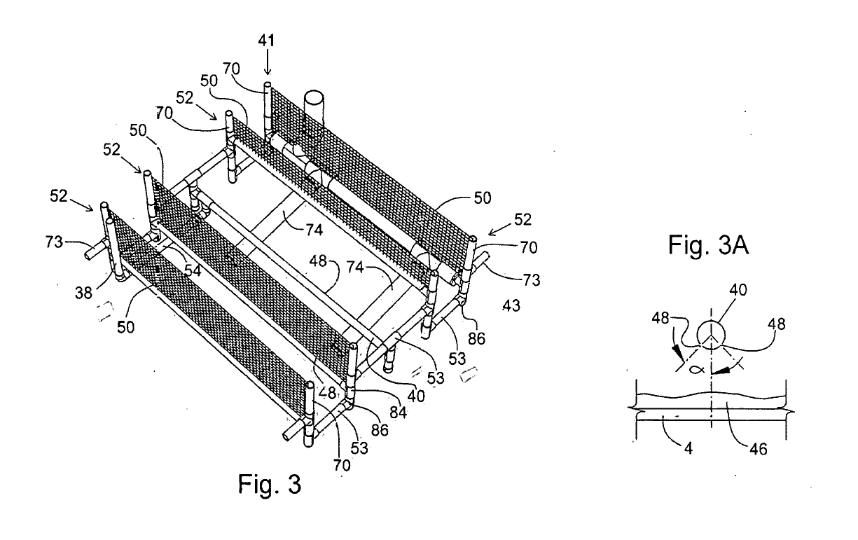

The distribution tube 40, as shown in FIG. 3, generally extends centrally along a length of the septic tank 4 from a leading end 41 of the foldable and removable partition assembly 12 to a trailing end 43 of the foldable and removable partition assembly 12. The distribution tube 40 is typically supported by the foldable and removable partition assembly 12 between about 6 and 12 inches above the bottom surface of the septic tank 4 and extends parallel to the bottom surface of the septic tank 4. The distribution tube 40 has a plurality of distribution outlets or holes 48 formed in the side wall thereof for discharging the pumped treated effluent, supplied by the holding tank 18, downwardly and laterally from the distribution tube 40 toward the bottom surface and the opposed side walls of the septic tank 4, e.g., at a discharge angle α of between about 20 to 70 degrees relative to an axis extending normal to the bottom surface (see FIG. 3A). Each one of the distribution holes 48 has a diameter between 1/16 and 1 inch, for example. Preferably, the size of the distribution holes 48, along the length of the distribution tube 40, gradually increases in diameter, from adjacent the inlet end toward adjacent the outlet end of the septic tank 4 in order to facilitate generating a substantially uniform flow and discharge of the treated effluent from each one of the distribution holes 48.

The discharged treated effluent, from the distribution holes 48, is designed to directly flow into the sludge or waste material 46, contained on the bottom of the septic tank 4, and mix, stir and at least temporarily suspend a portion of such sludge or waste material 46 within the effluent contained within the septic tank 4. Such suspension of solids material, within the effluent contained within the septic tank 4, facilitates accumulation and collection of solid particles of the sludge or waste material 46 on plastic meshes or screens 50 of longitudinal panels 52, discussed below in further detail. Such suspension, accumulation and collection of solid particles of the sludge or waste material 46 thereby results in improved processing of the sludge or waste material 46 and a further discussion concerning the same will be provided below.

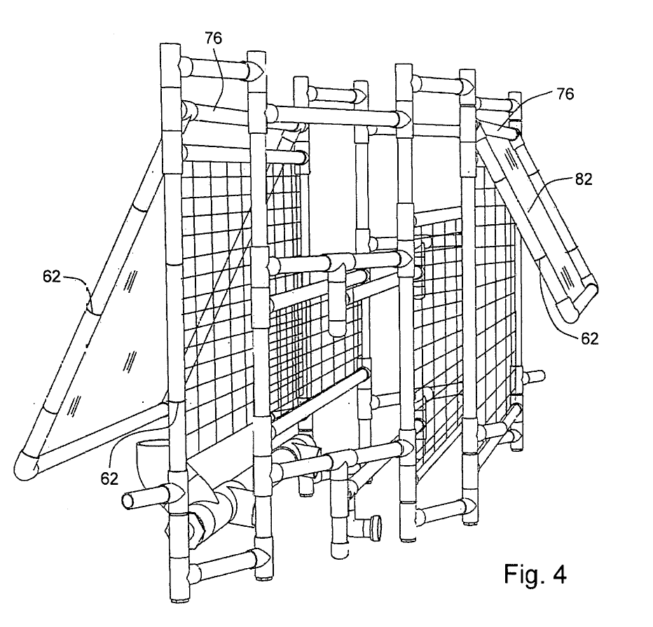

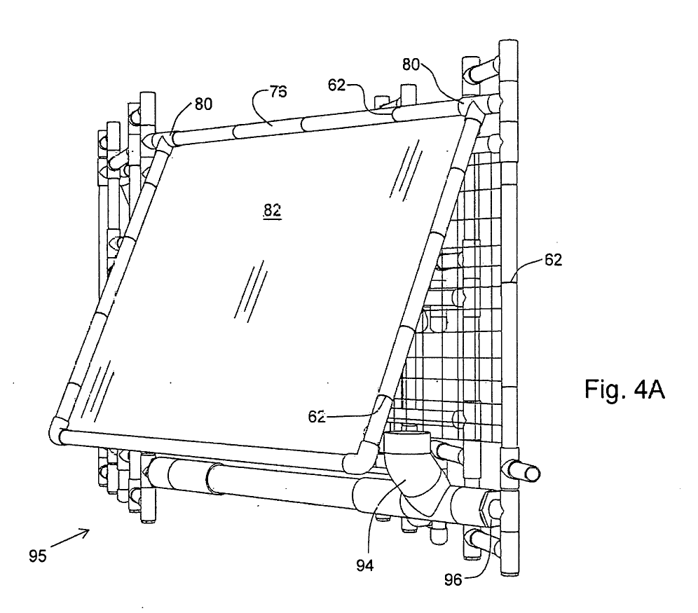

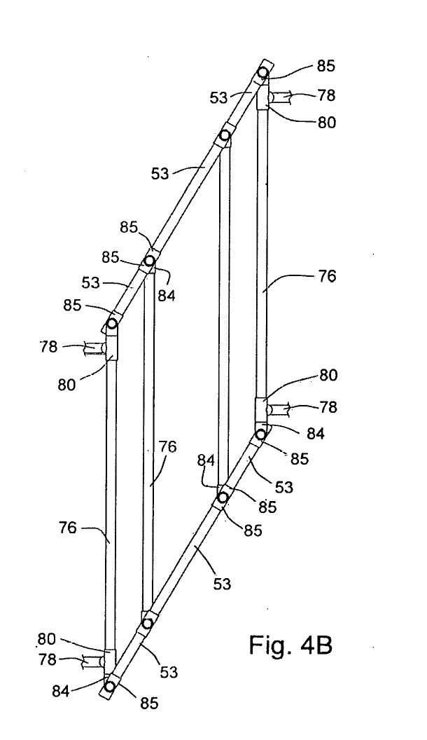

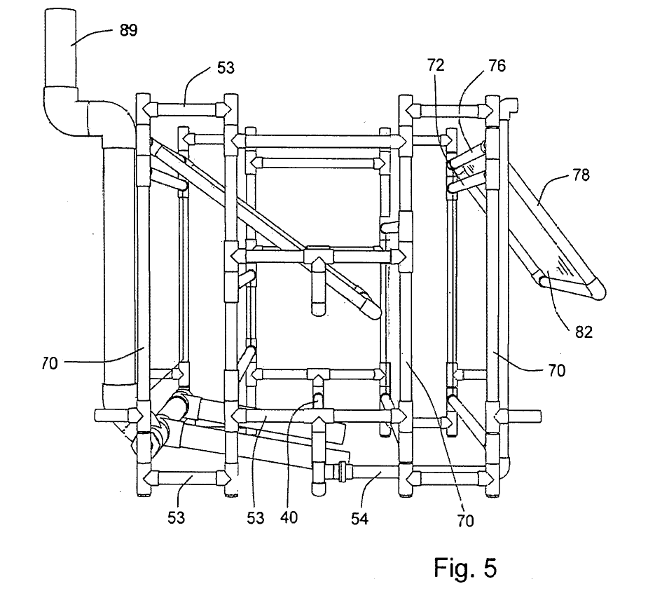

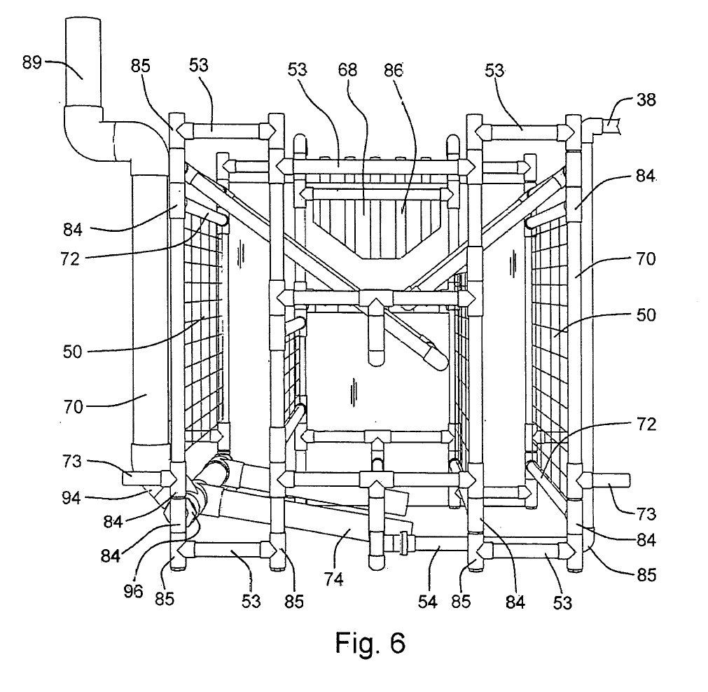

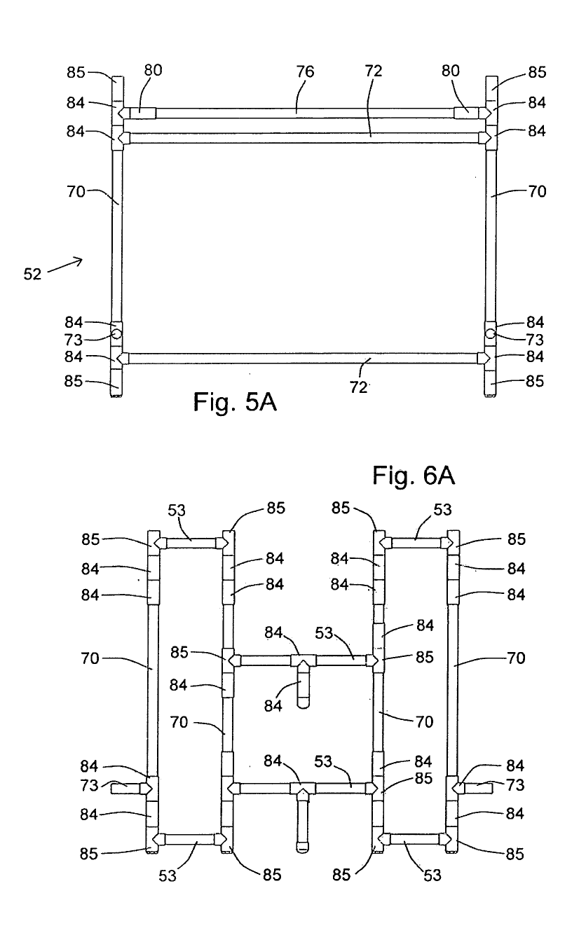

It is to be appreciated that when the foldable and removable partition assembly 12 is in its transportation state (see FIGS. 4, 4A, 4B), a distribution tube detachable conduit section 54 of the distribution tube 40 is removed therefrom in order to facilitate folding and transportation of the foldable and removable partition assembly 12. FIG. 5 shows the distribution tube detachable conduit section 54 detached from the distribution tube 40, while FIGS. 6, 8 and 9 show the distribution tube detachable conduit section 54 being attached to the distribution tube 40. The detachable conduit section 54 of the distribution tube 40 is transported along with the foldable and removable partition assembly 12. When the foldable and removable partition assembly 12 arrives at an installation site, the foldable and removable partition assembly 12 is then unfolded and expanded into its use configuration. Thereafter, a first end of the detachable conduit section 54 of the distribution tube 40 is connected to the distribution tube 40 (see FIGS. 6, 8, 9) while a second end of the detachable conduit section 54 of the distribution tube 40 is connected to the septic tank return conduit 38 to complete the supply conduit for supplying treated effluent back to the septic tank 4.

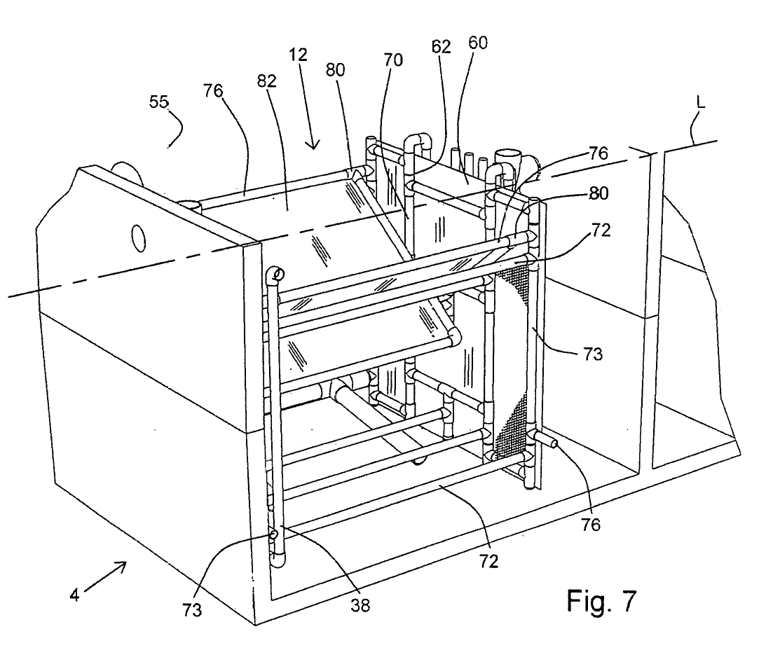

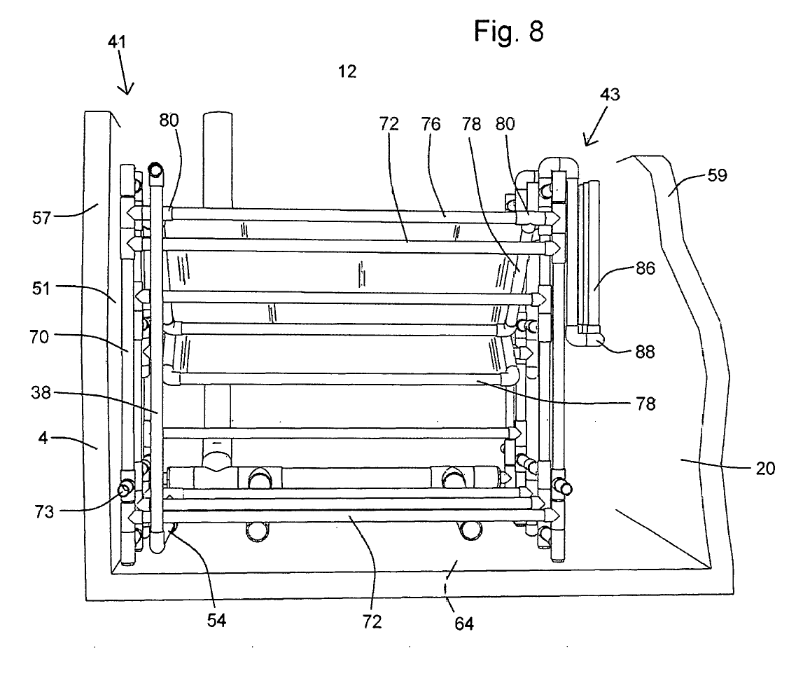

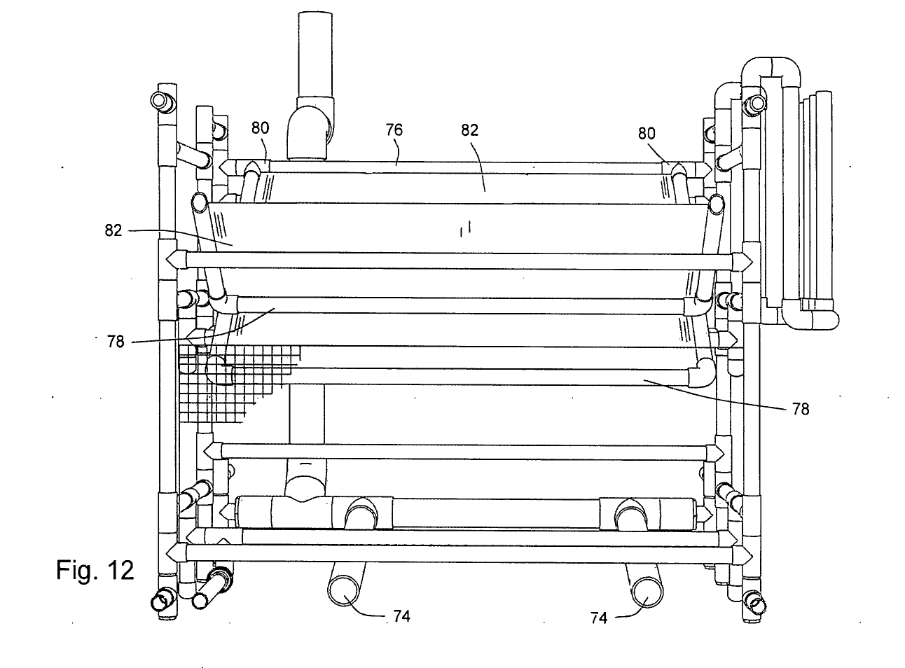

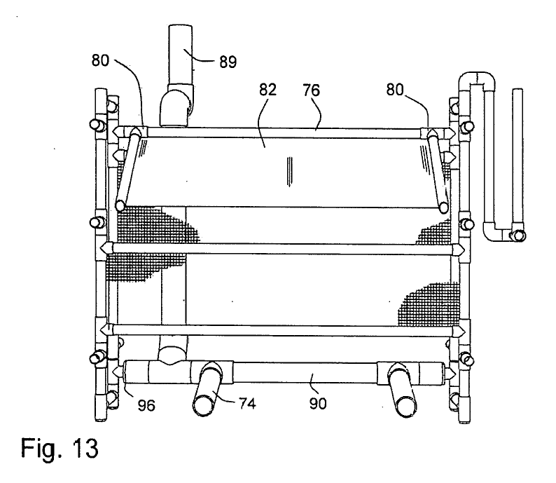

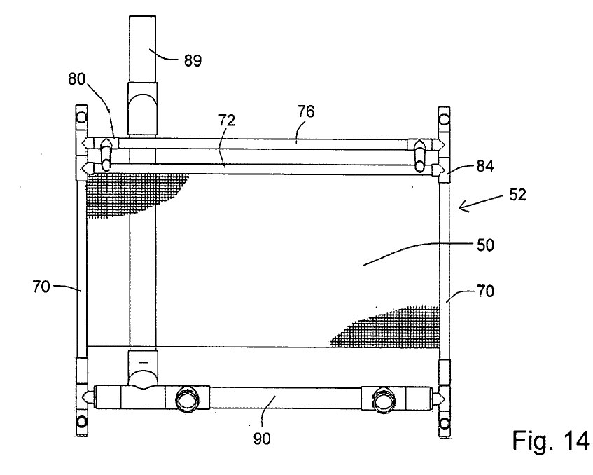

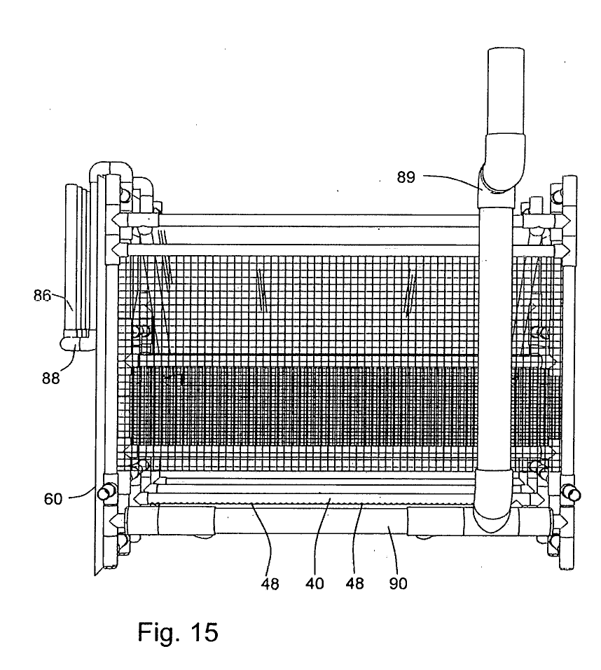

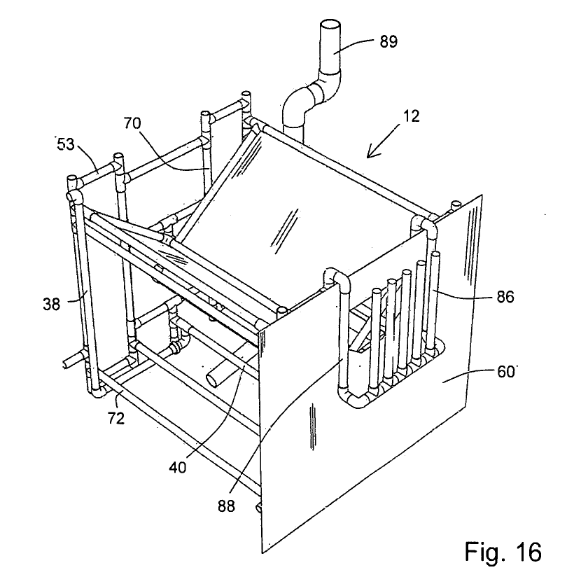

With reference now to FIGS. 3-16, a detailed description concerning the various other components of the foldable and removable partition assembly 12 will now be discussed. As shown in these figures, the foldable and removable partition assembly 12 comprises a foldable/expandable assembly which comprises a plurality, e.g., typically four or more, of separate spaced apart longitudinal collection panels 52 which are each connected with one another via a plurality of lateral pipes or components 53 to form an assembly framework or structure. Each one of the longitudinal panels 52 has a length which is less than a longitudinal length of the septic tank 4 and, during use, extends generally parallel to the longitudinal axis L and the side walls 55 of the septic tank 4 (see FIG. 7). As shown in FIG. 8, the installed foldable and removable partition assembly 12 is located within the septic tank 4 slightly closer to the inlet end 57 than the outlet end 59 thereof. Due to the location of the foldable and removable partition assembly 12, an inlet chamber 51 may be typically formed between the inlet end 57 of the septic tank 4 and the leading end 41 of the foldable and removable partition assembly 12 while the clarified effluent zone or region 20 is formed between the outlet end 59 of the septic tank 4 and the trailing end 43 of the foldable and removable partition assembly 12.

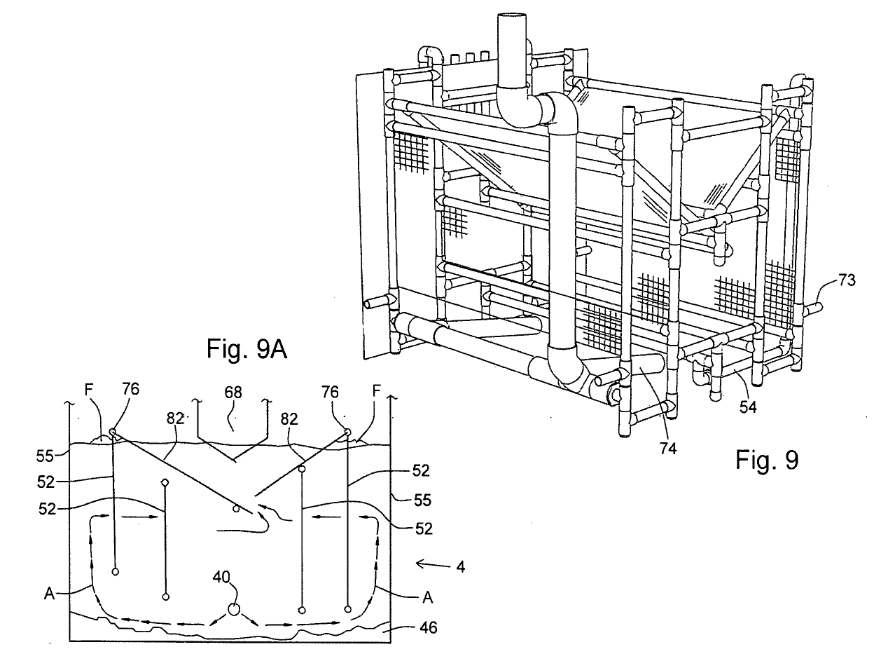

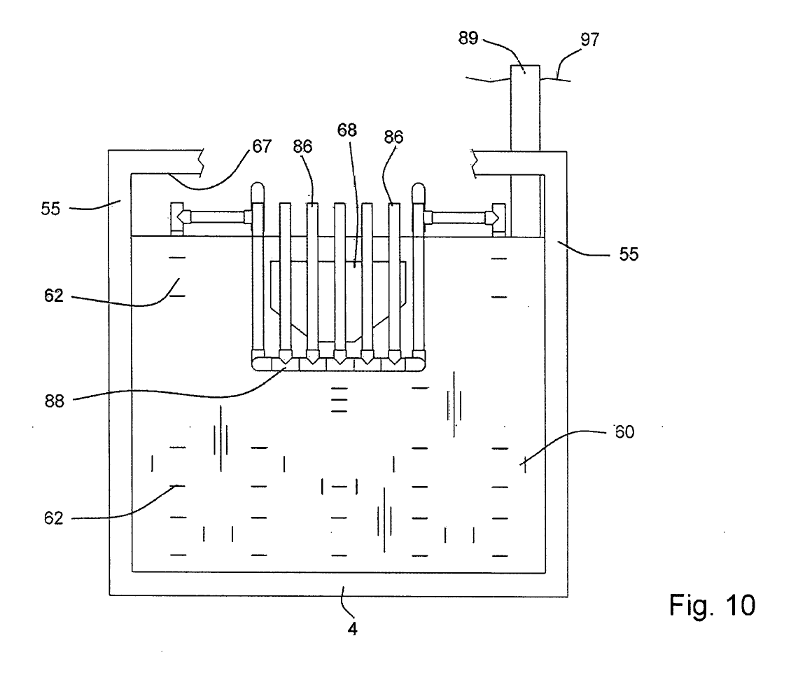

An outlet plastic membrane or sheet 60 extends completely across the trailing end 43 of the foldable and removable partition assembly 12 for forming a barrier which partitions the clarified effluent zone or region 20 from the remainder of septic tank 4. The outlet plastic sheet 60 is secured to the trailing end 43 of the foldable and removable partition assembly 12, by a plurality of spaced apart plastic tie members 62, and the outlet plastic sheet 60 is sufficiently wide so that the opposed lateral edges of the outlet plastic sheet 60 abut and overlap along opposed lateral sidewalls 55 of the septic tank 4 to provide a seal therewith (see FIG. 10). As a result of such arrangement, the outlet plastic sheet 60 generally forms a partition or a barrier which partitions the septic tank 4 thereby creating separate and distinct zones or regions in the septic tank 4, including at least an inlet/treatment zone or region 21 and a clarified effluent zone or region 20 (see FIGS. 1 and 2). As will be discussed in more detail below, the foldable and removable partition assembly 12 comprises baffles 82 which divides the inlet/treatment zone or region 21 into at least a treatment/sludge zone or region 64 and an inlet/scum zone or region 56 which are distinct from the clarified effluent zone or region 20 (see FIG. 9A).

It is possible to secure an inlet plastic membrane or sheet completely across the leading end 41 of the foldable and removable partition assembly 12 to assist with partitioning the inlet chamber 51 from the treatment/sludge zone or region 64 while an outlet plastic membrane or sheet 60 extends completely across the trailing end of the foldable and removable partition assembly 12 for partitioning the clarified effluent zone or region 20 from the remainder of septic tank 4. The inlet plastic sheet and the outlet plastic sheet 60 would be secured to the leading or the trailing ends of the foldable and removable partition assembly 12, by a plurality of spaced apart plastic tie members 62, and have a sufficient width so that the opposed lateral edges of the inlet plastic sheets would abut and overlap along opposed lateral sidewalls of the septic tank 4 to provide a seal therewith. A wastewater supply opening or inlet may be formed or cut in the inlet plastic sheet to facilitate the flow of the sludge or waste material 46 from the inlet chamber 51 into the treatment/sludge zone or region 64 of the septic tank 4 for processing. The supply opening or inlet would typically be formed or cut in the lowermost portion of the inlet plastic sheet.

It is to be appreciated that the foldable and removable partition assembly can be configured so as to form a zone toward the bottom of the inlet/treatment zone to hold or retain solids at the bottom of the tank. This could be accomplished by horizontal sheets having holes, slits or passages that would prevent the solids from rising above the sheet and as the effluent is treated. Such horizontal sheets can be, for example, at least one of the materials selected from the group consisting of nylon mesh, metallic mesh, plastic mesh, fiberglass mesh, fabric mesh, woven wood and plastic or any other suitable material. It is to be further appreciated that the septic tank 4 can be partitioned into any number of independent and separate zones or regions by means of different configurations of plastic sheets, e.g., plastic sheets arranged vertically, horizontally and vertically and/or horizontally.

As shown in FIGS. 6 and 10, a discharge opening or outlet 68 is formed in the outlet plastic sheet 60 to facilitate the flow of the effluent from the inlet/treatment zone or region 21 of the septic tank 4 into the clarified effluent zone or region 20. The discharge opening or outlet 68 is typically formed in the uppermost portion of the outlet plastic sheet 60, e.g., adjacent the top surface 67 of the septic tank 4 so that only sufficiently treated effluent, and possibly some floating scum, is permitted to flow therethrough and into the clarified effluent zone or region 20. Again, it is to be appreciated that the size, the shape and the location of the discharge opening or outlet 68 can vary from application to application without departing from the spirit and scope of the present invention.

Each one of the longitudinal panels 52 generally comprising a leading and trailing pair of spaced apart vertical legs 70 which are interconnected with one another via at least two transverse arms 72 (see FIG. 5A). The connection of the pair of spaced apart vertical legs 70 with the at least two transverse arms 72 is a fixed coupling 84 so that each longitudinal panel 52 forms a substantially rigid structure. As generally shown in the drawings, a plastic mesh or screen 50 is connected to and extends between the opposed vertical legs 70 and the two transverse arms 72 of the longitudinal panels 52. The plastic mesh or screen 50 is typically manufactured from new or recycled plastic, for example, and can have a mesh size of 1/16 inches to 3 inches, for example. Typically the surface area of the plastic mesh or screen 50, supported by the two laterally outer longitudinal panels 52, is greater than the surface area of the plastic mesh or screen 50 which is supported by the two or more interior longitudinal panels 52.

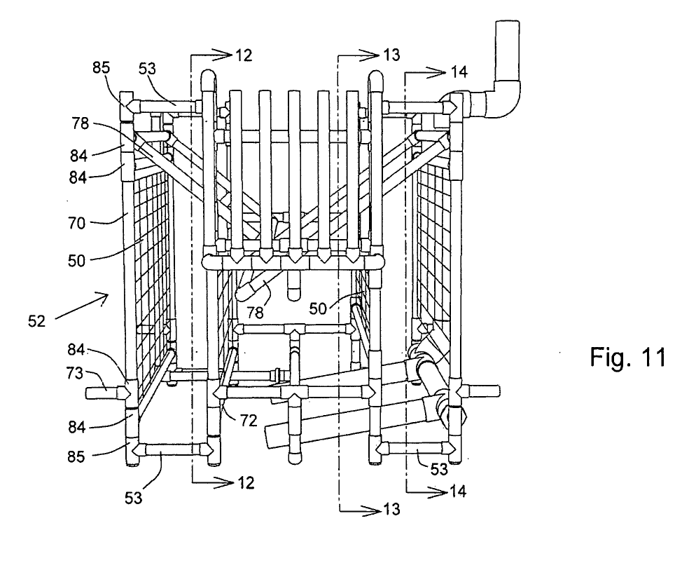

As shown in FIG. 11, the lowermost transverse arm 72 of only the first longitudinal panel 52 (right hand side of FIG. 11) includes a pair of stepped sections which are arranged to step around a pair of space apart secondary waste removal conduits 74, discussed below in further detail. The vertical legs 70 and transverse arms 72 of each longitudinal panel 52 is typically manufactured from conventional PVC piping and has a diameter of between 1 to 3 inches, for example, preferably 1¼ inches.

The vertical legs 70 of the laterally outer longitudinal panels 52 each support a laterally extending spacer 73 which generally communicate with the lateral sidewalls 55 of the septic tank 4 so as to laterally space the foldable and removable partition assembly 12 at a desired distance from the lateral sidewalls 55 of the septic tank 4. Generally, the laterally extending spacer 73 is connected to the vertical legs 70 of the outer longitudinal panels 52 by a fixed coupling 84.

Each of the lateral outer longitudinal panels 52 further includes a baffle support arm 76 which extends between an upper most portion of the pair of vertical legs 70. A respective rigid U-shaped baffle framework 78 is supported by each one of the baffle support arms 76. Both opposed free ends of the U-shaped baffle framework terminate at a pivotable T-shaped coupling 80 which has a through bore which is sized to be slightly larger in diameter than an external diameter of the baffle support arm 76. The baffle support arm 76 passes through the through bore of the T-shaped coupling 80 so as to form a pivotable coupling which facilitates pivoting or rotation of the U-shaped baffle framework 78 relative to the baffle support arm 76. An impermeable membrane 82 is supported by the baffle framework 78, via a plurality of spaced apart conventional tie members 62, and pivotable together with the baffle framework 78 (see FIGS. 4, 4A, 5). Each one of the impermeable membranes 82 is designed to prevent foam and other fluids from passing therethrough and separate the inlet/scum zone or region 56 from the treatment/sludge zone or region 64.

As shown in FIGS. 6 and 11, the width of the first baffle framework 78 is shorter than the width of the second baffle framework 78. As a result of this, when the foldable and removable partition assembly 12 is in its use configuration and the first baffle framework 78 is pivoted into its “use” position, a free end portion of the first baffle framework 78 rests against a transverse arm 72 of an immediately adjacent longitudinal panel 52, as generally shown in FIG. 5. Similarly, when the second baffle framework 78 is pivoted into its “use” position, a free end portion of the second baffle framework 78 rests against a central transverse arm 72, as generally shown in FIG. 9. As a result of such configurations, the first and the second baffle frameworks 78 overlap one another while still providing a flow passage therebetween which permits effluent to flow between a lower portion of the inlet/treatment zone or region 21, e.g., the area below the first and the second baffle frameworks 78 which is referred to as the treatment/sludge zone or region 64 and the inlet/scum zone or region 56, e.g., above the first and the second baffle frameworks 78, and eventually out through the discharge opening or outlet 68 formed in the outlet plastic sheet 60. As discussed above, each baffle framework 78 is supported on the baffle support arm 76 by pivotable couplings 85 which facilitate pivoting of the baffle framework 78 into a “use” position (see FIGS. 7-9, for example) and a “transportation” position (see FIGS. 4 and 4A) as well as any intermediate position therebetween (see FIG. 4B).

The flow pattern of effluent and suspended solid waste is generally shown in FIG. 9A. After entering the septic tank 4, the effluent and suspended solid waste generally flows from the inlet/scum zone or region 56 down between the first and the second baffle frameworks 78 into the treatment/sludge zone or region 64 then, as diagrammatically illustrated by dashed arrows A, laterally outward toward the sidewalls 55 of the septic tank 4. This is due at least in part to the treated effluent that has been pumped back to the septic tank 4 through the septic tank return conduit 38 directly to a distribution tube 40 located within the septic tank 4 adjacent a lower portion thereof. The flow of effluent and suspended solid waste is generally directed upward by the sidewalls 55 of the septic tank 4 at which point the effluent circulates inward first through the laterally outer longitudinal panels 52 and then through the two laterally inner longitudinal panels 52. As the effluent flows and circulates through the septic tank 4, the laterally outer and inner panels 52 prevent solid waste material from passing therethrough. The laterally outer longitudinal panels 52 generally trap and collect larger particle solid waste while the laterally inner longitudinal panels 52 generally trap and collect smaller particle solid waste. The suspended solid waste may collect on the outer sides of the inner and outer longitudinal panels 52 and then fall to and collect on the bottom surface of the septic tank 4. As the level of effluent increases within the septic tank 4, any foam F that accumulates on the surface of the effluent is typically trapped by the impermeable membranes 82 and generally minimizes the amount of foam F which passes out through the discharge opening or outlet 68 in the outlet plastic sheet 60 and into the clarified effluent zone or region 20.

In order to permit folding of the foldable and removable partition assembly, the different elements of the framework such as the longitudinal panels and baffle frameworks and associated pipes, components, legs or arms are generally connected to each other by fixed couplings 84 or pivotable couplings 80, 85. These couplings are formed by T-shaped couplings 80, 85 and enable the baffle panels and frameworks to either be pivotable or fixed in relation to each other and the associated pipes, components, legs or arms. Pivotable couplings are formed by a T-shaped coupling 85 that has a through bore which is sized to be slightly larger in diameter than an external diameter of the section of the associated pipe, component, leg or arm, i.e., have a clearance fit therewith, so that the T-shaped coupling 85 is able to freely rotate or pivot with respect to the associated pipe, component, leg or arm. The section of the pivotable T-shaped coupling 85 that extends perpendicular to the through bore can be fastened or rigidly secured to a panel or framework by any appropriate means including adhesive, glue, bonding agent, compression fit, and/or nut and bolt connectors, for example. Due to the rigid connection with the panel or baffle framework and the rotatable connection with an associated pipe, component, leg or arm, pivotable T-shaped couplings 85 enable the longitudinal panels and baffle frameworks to pivot with respect to each other and enable the framework to be “folded” for transportation or storage.

Each one of the longitudinal panels 52 is coupled to the adjacent longitudinal panels 52 via pivotable couplings 85 (see FIG. 6A). Similar to the pivotable couplings 80 described above in relation to the baffle frameworks 78, a pivotal T-shaped coupling 85 is supported along a section of the vertical pipe forming part of the vertical leg 70 of the longitudinal panel 52. The T-shaped coupling 85 has a through bore which is sized to be slightly larger in diameter than an external diameter of the section of the vertical pipe or leg 70, i.e., have a clearance fit therewith, so that the T-shaped coupling 85 is able to freely rotate or pivot with respect to the vertical leg 70. In a similar manner, an immediately adjacent longitudinal panel 52 supports a corresponding T-shaped coupling 85 at the same vertical position along a corresponding vertical leg 70 of the immediately adjacent longitudinal panel 52. A lateral pipe or component 53 couples the corresponding pair of pivotable T-shaped couplings 85 to thereby interconnect the two adjacent longitudinal panels 52 with one another in a pivotable manner in order to facilitate folding of the foldable and removable partition assembly 12. It is to be appreciated that the each longitudinal panel 52 is coupled with each immediately adjacent longitudinal panel 52 by at least two corresponding pair of pivotable T-shaped couplings 85, as described above, so that the foldable and removable partition assembly 12 is able to be folded and collapsed into a folded transportation configuration, as generally shown in FIGS. 4, 4A and 4B, during storage and/or transportation of the foldable and removable partition assembly 12, and then be readily unfolded and expanded, at the installation site, into its use configuration prior to installation of the foldable and removable partition assembly 12 into the septic tank 4.

In contrast to a pivotable coupling 85, a fixed coupling 84 is to be understood as being a connection which prevents pivoting, rotation or movement between the associated pipes, components, legs or arms. For example, each longitudinal panel 52 is formed by means of four fixed T-shaped couplings 84 (see FIG. 5A). The T-shaped couplings 84 securely connect a vertical leg 70 to an end of a transverse arm 72 such that the structure of the panel 52 is rigid. The fixed connections between the T-shaped couplings 84 and the associated pipes, components, legs or arms can be formed by means of adhesive, glue, a bonding agent, compression fit, and/or nut and bolt connectors, for example.

It is to be appreciated that the particular arraignment of fixed couplings 84 and pivotable couplings 80, 85 of the foldable and removable partition assembly as shown in the Figures and described herein could be changed while still achieving the objective of enabling folding or the partition assembly. For example, the fixed couplings 84 connecting transverse arms 72 and the baffle support arm 76 to the vertical leg 70 could be pivotable couplings 85 and the pivotable couplings 85 connecting the lateral pipes or components 53 to the vertical legs 70 could be fixed couplings 84. This alternate arrangement of fixed and pivotable couplings could enable the longitudinal panels and baffle frameworks to pivot with respect to each other and enable the framework to be “folded” for transportation and/or storage.

If this alternate arrangement of fixed and pivotable couplings were used in the construction of the foldable and removable partition assembly 12, it may be necessary to have one or more vertical stop members. Stop members generally includes components having a larger diameter than the through bore of the pivotable T-shaped coupling, that are generally located vertically below the pivotable T-shaped coupling to maintain the pivotable T-shaped coupling at the desired vertical orientation along the vertical leg, for example.

The clarified effluent zone or region 20 of the septic system 2 accommodates a replaceable/replenishable supply of metal 86 which facilitates removing phosphorus-, in a conventional manner, from the effluent which eventually flows out of the septic tank 4 through the outlet T-shaped connector 9. As shown in FIGS. 8 and 10, a support rack 88 for metallic members or components 86 is supported by an upper most portion of the trailing vertical legs 70 of two laterally inner longitudinal panels 52 of the foldable and removable partition assembly 12. The support rack 88 for the metallic members or components 86 is typically supported by the foldable and removable partition assembly 12 and generally extends downwardly into the effluent which is accommodated within an upper area of the clarified effluent zone or region 20 and generally parallel to the trailing end 43 of the foldable and removable partition assembly 12. It is to be appreciated that the support rack 88 must be sufficiently submerged, within the effluent contained within the clarified effluent zone or region 20, in order to facilitate reaction of the phosphorus with the metallic members or components 86 and removal of an adequate amount of phosphorus contained within the effluent, prior to discharging the treated effluent from the septic tank 4.

The support rack 88 is typically located within the clarified effluent zone or region 20 so as to facilitate access thereto and replacement of the metallic members or components 86, by service personnel, in the event that the metallic members or components 86 eventually become “spent” or depleted. The metallic members or components 86 may be either aluminum, steel, iron or virtually any other desired metal or may possibly comprise metal filings of one or more the above described metals. As generally shown, the support rack 88 is designed to support five separate metallic members or components 86. It is to be appreciated, however, that the number of and size of the separate metallic members or components 86 to be supported by the support rack 88 in the clarified effluent zone or region 20 as well as the spacing of the separate metallic members or components 86 from one another can vary from application to application. The separate metallic members or components 86 operate in a conventional manner to remove phosphorus from the effluent located within the clarified effluent zone or region 20 prior to the treated effluent being permitted to flow from the clarified effluent zone or region 20 toward the aerobic system 25 and/leach field 13

As shown in FIGS. 6, 9 and 13, the foldable and removable partition assembly 12 is equipped with a generally vertical waste removal conduit 89 which communicates with a main waste removal conduit 90 that is supported by the first longitudinal panel 52. The main waste removal conduit 90 generally extends longitudinally in the inlet/treatment zone or region 21 along the length of the first longitudinal panel 52 and parallel to the bottom surface of the septic tank 4. The pair of spaced apart secondary waste removal conduits 74 project from the main waste removal conduit 90 downwardly toward a central area of the bottom surface of the septic tank 4. The main waste removal conduit 90 and the pair of spaced apart secondary waste removal conduits 74 each typically comprises 3 inch PVC piping. A free end of each one of the pair of secondary waste removal conduits 74 is open and thus forms a pair of spaced apart primary inlets for the main waste removal conduit 90 and the vertical waste removal conduit 89 which facilitate sucking and removing excess sludge or waste material 46 directly from the bottom surface of the septic tank 4.

A first end of the main waste removal conduit 90 is connected to coupling 94 which supports an expansion elbow, e.g., typically 4 inch PVC piping, that forms a discharge outlet of the waste removal conduit 90. An end surface 96 of the coupling 94 is partially open and thus forms a secondary inlet into the main waste removal conduit 90 (see FIG. 4A). A second opposite end 95 of the main waste removal conduit 90 is generally closed or sealed. However, it is to be appreciated, that the second opposite end 95 of the main waste removal conduit 90 may also be partially open to form a further secondary inlet to the main waste removal conduit 90. The expansion elbow is connected to the waste removal conduit 89 which extends vertically and passes through an opening, e.g., in a side wall or top surface of the septic tank 4. As shown in FIG. 10, the outlet of the vertical waste removal conduit 89 is located above ground 97 so as to be readily accessible by service personnel for servicing the septic tank 4, discussed below in further detail. The outlet of the vertical waste removal conduit 89 is typically closed by a removable cover (not shown).

When excess sludge or waste material 46 accumulates on the bottom surface of the septic tank 4 so that the septic tank 4 is either is not operating efficiently or is no longer functioning properly, e.g., once every few years or so, then the excess sludge or waste material 46 is removed from the bottom of the septic tank 4. That is, the septic tank 4 is serviced by bringing conventional septic pumping equipment to the site. The conventional septic pumping equipment is connected to the discharge outlet of the vertical waste removal conduit 89 of the foldable and removable partition assembly 12 to facilitate removal of excess sludge or waste material 46 from the bottom surface of the septic tank 4. During operation of the conventional septic pumping equipment, the excess sludge or waste material 46 in the septic tank 4 flows into the main waste removal conduit 90 via either the primary or the secondary inlets. The conventional septic pumping equipment continues sucking and removing excess sludge or waste material 46 from the bottom of the septic tank 4 until the conventional septic pumping equipment commences sucking air, via the secondary inlet(s), into the main waste removal conduit 90. Once this occurs, the vacuum “seal” is broken and an operator of the conventional septic pumping equipment readily becomes aware that the level of the sludge or waste material 46, still remaining within the septic tank 4, is generally reduce to the height of the main waste removal conduit 90. This typically signifies that a sufficient amount of excess sludge or waste material 46 has been removed from the bottom portion of the septic tank 4. Thereafter, the conventional septic pumping equipment is disconnected from the septic tank 4 and the septic tank 4 then recommences normal operation.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

Wherefore, I/we claim:

1. A foldable and removable partition assembly having both a collapsed configuration, which facilitates storage and transport of the foldable and removable partition assembly, and an expanded configuration which facilitates installation and use of the foldable and removable partition assembly within a septic tank;
the foldable and removable partition assembly comprising a framework, and the framework supporting first and second baffles forming part of a sludge chamber of the septic tank.

2. The foldable and removable partition assembly according to claim 1, wherein the foldable and removable partition assembly further comprises at least an outlet sheet for partitioning an outlet chamber of the septic tank from the sludge chamber of the septic tank.

3. The foldable and removable partition assembly according to claim 1, wherein the foldable and removable partition assembly further comprises at least one of mesh, screen and a plastic sheet for collection of suspended particles in the sludge chamber of the septic tank.

4. The foldable and removable partition assembly according to claim 1, wherein the foldable and removable partition assembly further comprises a supply of metal for removing phosphorus from at least one of sludge and waste material contained on a bottom of the septic tank.

5. The foldable and removable partition assembly according to claim 1, wherein the foldable and removable partition assembly further comprises a means for reintroducing effluent to a particular zone in the tank for removal of wastewater contaminants.

6. The foldable and removable partition assembly according to claim 1, wherein the foldable and removable partition assembly further comprises a means of removing of excess sludge so as to allow for adequate carbon to remain in the septic tank.

7. A foldable and removable partition assembly having both a collapsed configuration, which facilitates storage and transport of the foldable and removable partition assembly, and an expanded configuration which facilitates installation and use of the foldable and removable partition assembly within a septic tank;
the foldable and removable partition assembly comprising a framework, and the framework supporting:
at least an outlet sheet which partitions the septic tank into a sludge chamber which receives a flow of wastewater and an outlet chamber which receives a flow of at least partially processed effluent from the sludge chamber;
first and second baffles arranged in the sludge chamber partitioning the sludge chamber into an inlet chamber and a treatment chamber of the septic tank;
at least one of mesh or screen arranged in the treatment chamber for collection of suspended particles in the treatment chamber of the septic tank.

8. The foldable and removable partition assembly according to claim 7, wherein the framework comprises a plurality of longitudinal panels that are coupled to each other by lateral pipes and pivotable couplings such that the longitudinal panels are laterally movable relative to each other to facilitate changing the foldable and removable partition assembly between the collapsed configuration and the expanded configuration.

9. The foldable and removable partition assembly according to claim 8, wherein, in the collapsed configuration of the foldable and removable partition assembly, the plurality of longitudinal panels are laterally closer to each other than when the foldable and removable partition assembly is in the expanded configuration.

10. The foldable and removable partition assembly according to claim 8, wherein the plurality of longitudinal panels comprises laterally outer longitudinal panels, each of the outer longitudinal panels comprises a baffle support arm that extends longitudinally from one vertical leg to another vertical leg, the baffle support arms support the first and the second partially overlapped baffles via further pivotable couplings such that the first and the second partially overlapped baffles are pivotable with respect to the respective outer longitudinal panels.

11. The foldable and removable partition assembly according to claim 8, further comprising a distribution tube arranged in the inlet/treatment zone, the distribution tube receiving a flow of previously treated effluent and distributing the flow of previously treated effluent into the inlet/treatment zone for mixing up sludge or waste material contained on a bottom of the septic tank.

12. The foldable and removable partition assembly according to claim 8, further comprising a main waste removal conduit arranged in the inlet/treatment zone adjacent a bottom of the septic tank and which extends towards an exterior of the septic tank to facilitate removal of sludge or waste material contained on a bottom of the septic tank.

13. The foldable and removable partition assembly according to claim 8, wherein each of the longitudinal panels comprises a pair of transverse arms that are connected, via fixed couplings, to a pair of vertical legs; and
each one of the longitudinal panels supports one of the mesh or the screen such that the mesh or the screen extends between the transverse arms and the vertical legs of the respective longitudinal panel.
